(19) United States
(12) Patent Application Publication
(10) Pub. No.: US 2026/0318127 A1
(43) Pub. Date: Oct. 15, 2026

(54) VEHICLE HANDLE DEVICE

(71) Applicant: ALPHA CORPORATION, Kanagawa (JP)

(72) Inventor: Takao TOYAMA, Kanagawa (JP)

(73) Assignee: ALPHA CORPORATION, Kanagawa (JP)

(21) Appl. No.: 19/689,025

(22) Filed: May 27, 2026

Related U.S. Application Data
(63) Continuation of application No. PCT/JP2024/041751, filed on Nov. 26, 2024.

(30) Foreign Application Priority Data
Nov. 30, 2023 (JP) 2023-202813

(51) Int. Cl. E05B 85/10; E05B 85/16

(52) U.S. Cl. CPC E05B 85/107; E05B 85/16

(57) ABSTRACT

A vehicle handle device includes: a handle base fixed to a vehicle; a handle main body connected to the handle base and displaceable from an initial position by a drive device; a gear rotationally driven by the drive device; and a cam member having a fitted portion fitted to a fitting portion formed at a shaft end portion of the gear and configured to be rotationally driven by the gear via the fitted portion. The handle main body includes a driven portion in contact with the cam member and is displaceable by the cam member via the driven portion. In the cam member, the fitted portion thereof is formed at each of both ends of the cam member in a rotation axis direction, and a shape of the fitted portion is different between one end side and the other end side in the rotation axis direction.

### CROSS-REFERENCE TO RELATED APPLICATIONS

This is a continuation of International Application No. PCT/JP2024/041751 filed on Nov. 26, 2024, and claims priority from Japanese Patent Application No. 2023-202813 filed on Nov. 30, 2023, the entire content of which is incorporated herein by reference.

### TECHNICAL FIELD

The present disclosure relates to a vehicle handle device.

### BACKGROUND ART

As a handle device having a handle main body that can be pulled out from an initial position when a door is operated, a handle device described in JP2018-168689A is known.

A so-called pop-up type handle device of the related art including JP2018-168689A includes, for example, a handle main body rotatably connected to one end of an operation lever driven by an electric actuator fixed on a handle base, and an unlocking lever connected to an end opposite to a connection end of the handle main body to the operation lever. When the electric actuator is operated, the handle main body moves from the initial position where the handle main body is positioned on the same surface as a door panel to an operation position where the handle main body is raised from the door panel, and when the handle main body is operated at the operation position, a release operation of a door latch device can be performed.

In such a handle device, a cam member is rotationally driven by a motor as an electric actuator via a gear, the operation lever is operated by the rotational driving of the cam member, and the handle main body is moved to the operation position where the handle main body is raised from the door panel.

The handle devices described above may be respectively fixed to doors on both the left and right sides of a vehicle, and the left and right handle devices are configured such that arrangement thereof in a left-right direction is opposite to each other and a rotation operations thereof are reversed (that is, rotation directions are opposite). For this reason, it is necessary to prepare opposite-handed components (in particular, gears and cam members) in accordance with the left and right handle devices.

### TECHNICAL PROBLEM

The present disclosure provides a vehicle handle device that can share components regardless of whether the handle device is fixed to the left or right door of the vehicle.

### SUMMARY OF INVENTION

According to the present disclosure, a vehicle handle device includes a handle base fixed to a vehicle, a handle main body connected to the handle base and displaceable from an initial position by a drive device, a gear configured to be rotationally driven by the drive device, and a cam member having a fitted portion fitted to a fitting portion formed at a shaft end portion of the gear and configured to be rotationally driven by the gear via the fitted portion, in which the handle main body includes a driven portion in contact with the cam member and is displaceable by the cam member via the driven portion, and in the cam member, the fitted portion thereof is formed at each of both ends of the cam member in a rotation axis direction, and a shape of the fitted portion is different between one end side and the other end side in the rotation axis direction.

The shape of the fitted portion may be shaped such that a fitting angle between the gear and the cam member is different between the one end side and the other end side.

One of the fitting portion and the fitted portion may be formed in a substantially columnar shape, the other of the fitting portion and the fitted portion may be formed in a substantially cylindrical shape, the fitting portion may be provided with one of a protruding portion protruding in a radial direction and a groove portion fitted to the protruding portion, the fitted portion may be provided with the other of the protruding portion and the groove portion, the fitted portion may have an uneven region in which the protruding portion or the groove portion is provided and an arc region in which the protruding portion or the groove portion is not provided, and the uneven region and the arc region may be positionally deviated in a circumferential direction between the one end side and the other end side.

An initial position detection sensor configured to detect that the handle main body is disposed at the initial position, a pop-up position detection sensor configured to detect that the handle main body is disposed at a pop-up position pulled out from the initial position, and a circuit board on which the initial position detection sensor and the pop-up position detection sensor are mounted may be further provided.

The gear may have a detected portion on a circumference of a rotation surface of the gear, the circuit board may be configured such that the initial position detection sensor and the pop-up position detection sensor are disposed on a surface facing the detected portion, the vehicle handle device may be configured such that the initial position detection sensor detects approach of the detected portion to detect that the handle main body is disposed at the initial position, and the pop-up position detection sensor detects the approach of the detected portion to detect that the handle main body is disposed at the pop-up position, and the circuit board may be formed such that a front surface and a back surface are symmetrical.

### ADVANTAGEOUS EFFECTS OF INVENTION

According to the present disclosure, it is possible to provide a vehicle handle device that can share components regardless of whether the vehicle handle device is fixed to a left or right door of a vehicle.

### BRIEF DESCRIPTION OF DRAWINGS

FIG. 1 is a front view illustrating a vehicle handle device according to an embodiment of the present disclosure;

FIG. 2 is a cross-sectional view taken along a line X1-X1 of FIG. 1;

FIG. 3 is a view illustrating an operation of the vehicle handle device illustrated in FIG. 1;

FIG. 4 is a view illustrating an operation of the vehicle handle device illustrated in FIG. 1;

FIG. 5 is a perspective view of a rotation drive mechanism of the vehicle handle device illustrated in FIG. 1;

FIG. 6A is a top view of FIG. 5, illustrating a contact state between a rib of a main gear and an initial position detection sensor;

FIG. 6B is a top view of FIG. 5, illustrating a contact state between the rib of the main gear and a pop-up position detection sensor;

FIG. 7 is an exploded perspective view of a motor, a worm, a two-stage gear, a main gear, and a cam member illustrated in FIG. 5;

FIG. 8A is a top view of the cam member;

FIG. 8B is a bottom view of the cam member; and

FIG. 9 is a view illustrating a rotation drive mechanism in another handle device paired with the vehicle handle device illustrated in FIG. 1, which corresponds to FIG. 6A.

### DESCRIPTION OF EMBODIMENTS

A specific embodiment of the present disclosure will be described below with reference to the drawings.

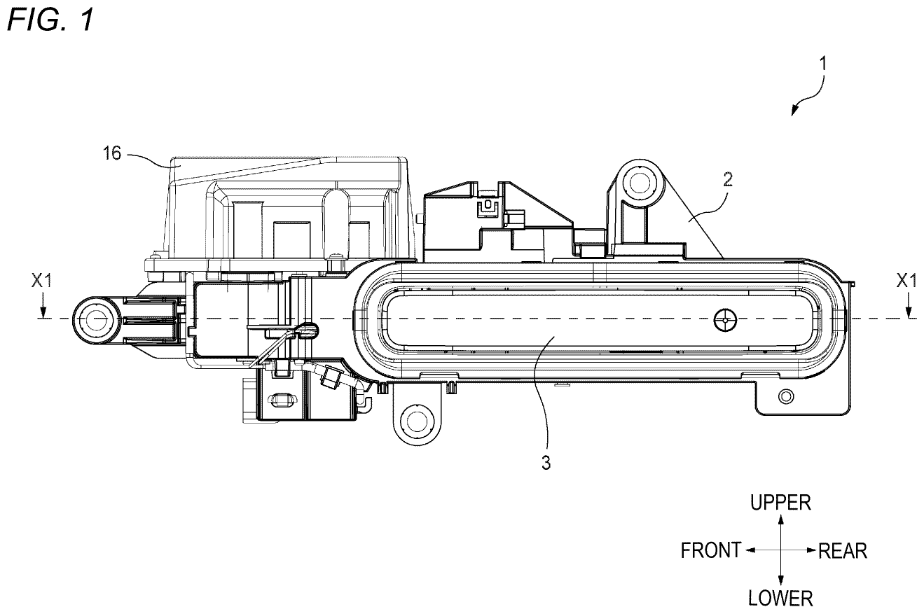

Hereinafter, for convenience of description, as illustrated in FIG. 1, “front”, “rear”, “left”, “right”, “upper”, and “lower” are defined. A “front-rear direction”, a “left-right direction”, and an “upper-lower direction” are orthogonal to each other.

Here, for example, each direction described above may correspond to each direction when a handle device 1 is mounted on a vehicle. In this case, the handle device 1 illustrated in FIG. 1 and the like is a handle device mounted on a left side of the vehicle. However, the handle device on the left side and a handle device on a right side have the same configuration except that arrangement in the left-right direction is opposite to each other and rotation operations thereof are reversed (that is, rotation directions are opposite).

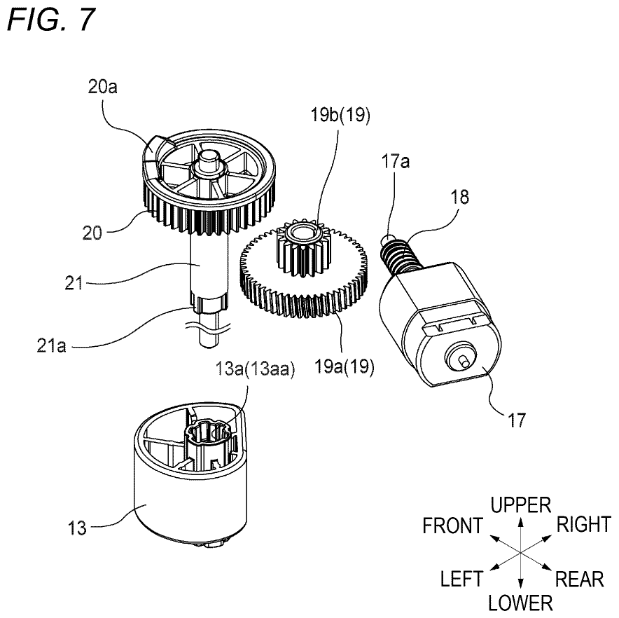

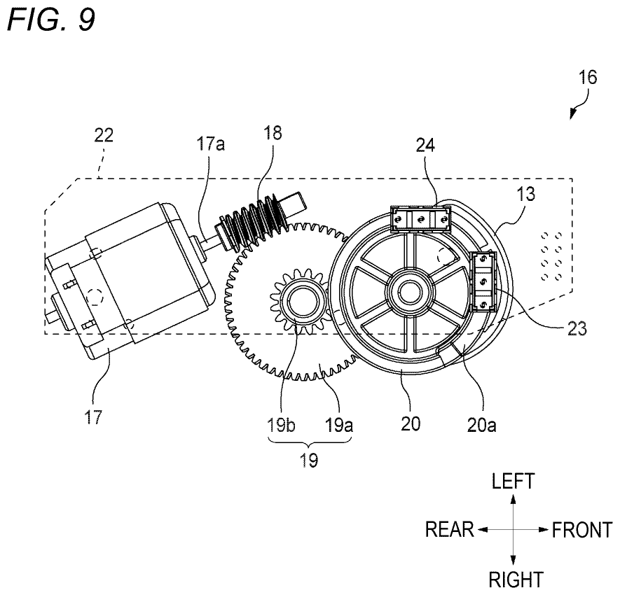

Hereinafter, for convenience of description, aspects illustrated in FIGS. 1 to 8B are configured as the handle device 1 fixed to the left side of the vehicle, and an aspect illustrated in FIG. 9 is configured as the handle device 1 fixed to the right side of the vehicle, but in practice, the aspects illustrated in FIGS. 1 to 8B may be configured as the handle device 1 fixed to the right side of the vehicle, or the aspect illustrated in FIG. 9 may be configured as the handle device 1 fixed to the left side of the vehicle.

As illustrated in FIG. 1, the handle device 1 includes a handle base 2, a handle main body 3, and a rotation drive mechanism 16 for moving the handle main body 3 between an initial position and a pop-up position, and is fixed to a door of the vehicle at the handle base 2.

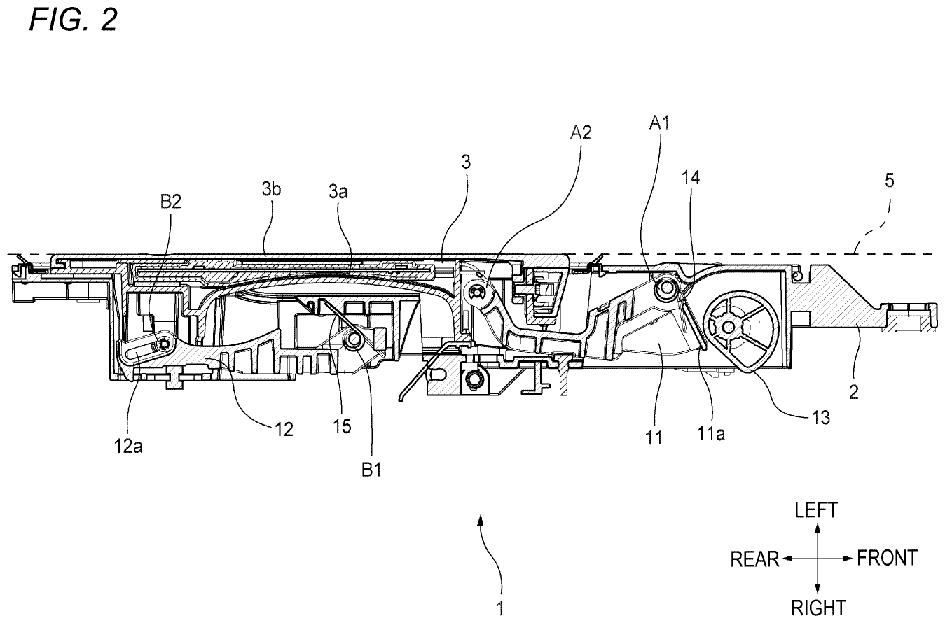

The handle main body 3 is connected to the handle base 2 by a first link 11 and a second link 12, a handhold portion 3a serving as a handhold at the time of door operation is formed in a central portion in the front-rear direction, and a surface 3b is substantially flush with a door surface 5 (door panel) in a state where the handle base 2 is fixed to the door (see FIG. 2).

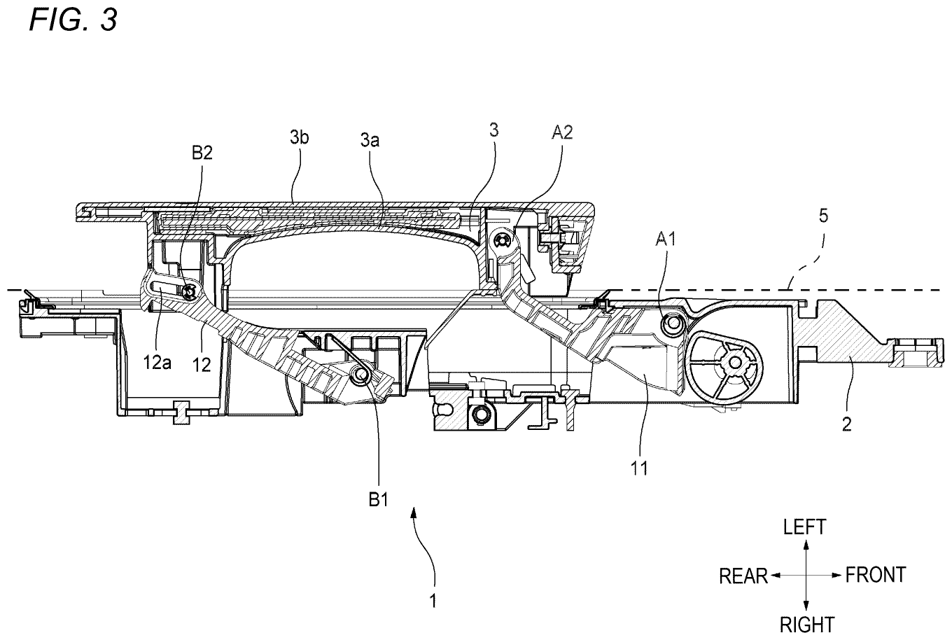

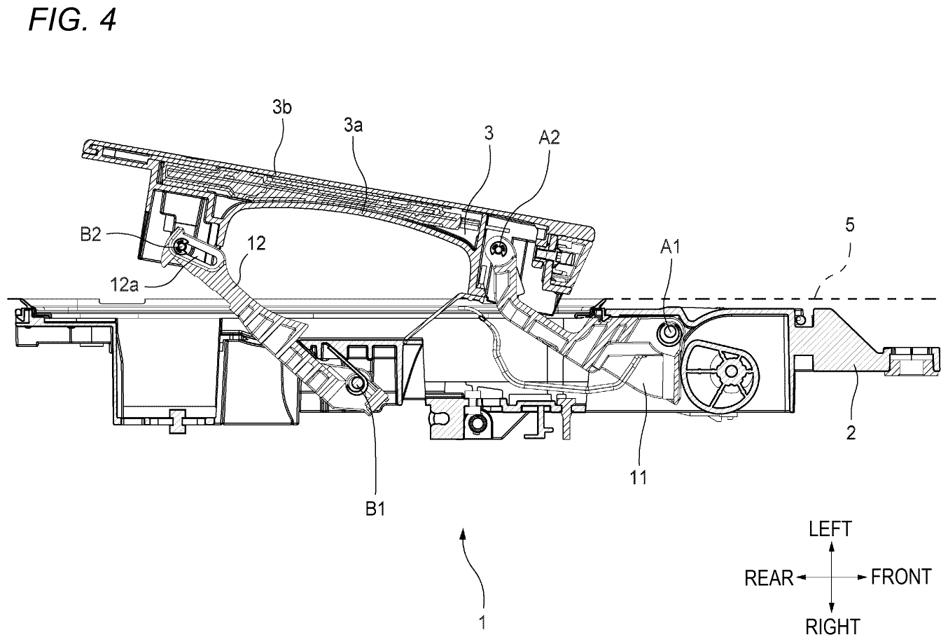

The handle main body 3 can be moved among the initial position (see FIG. 2) in which the handhold portion 3a is accommodated in the door, the pop-up position (see FIG. 3) in which the handhold portion 3a pops out from the door panel and the handle main body 3 can be operated by placing a hand on the handhold portion 3a, and a latch operation position (see FIG. 4) in which one end (in this example, a rear end) of the handle main body 3 is pulled up from the pop-up position.

A driven portion 11a of the first link 11 is pressed against the rotation drive mechanism (specifically, a cam member 13) that is rotationally driven, and the first link 11 is rotationally driven around a connecting shaft (A1) to the handle base 2. In order to maintain a pressure contact state between the driven portion 11a and the cam member 13, a counterclockwise rotational moment is applied to the first link 11 by a torsion spring 14. A detailed configuration of the rotation drive mechanism 16 including the cam member 13 will be described later.

An end of the first link 11 opposite to a connection end of the first link 11 to the handle base 2 is rotatably connected to one end of the handle main body 3 about a connecting shaft (A2).

One end of the second link 12 is rotatably connected to the handle base 2 about a connecting shaft (B1). A long hole 12a is formed at an opposite end of the second link 12, and a connecting shaft (B2) fixed to the other end of the handle main body 3 is rotatably and slidably inserted.

Therefore, component members of the handle device 1 constitute a five-node link mechanism (see FIGS. 2 to 4) having the handle base 2 as a fixed link, the first link 11 and the second link 12 connected to the fixed link by revolute pairs at intervals between the connecting shafts (A1, B1), a slider (the long hole 12a) connected to the second link 12 by a sliding pair, and the handle main body 3 having both ends connected to the first link 11 and the slider in a revolute pair, as elements.

A sliding stroke end of the slider sliding on the second link 12 is determined in advance as an end position of the long hole 12a, and in addition to the rotational moment applied to the first link 11 described above, a counterclockwise rotational moment is applied to the second link 12 by a torsion spring 15, whereby the slider is held at a stroke end position on the connecting shaft (B1) side of the second link 12 to the handle base 2.

Since link lengths of the fixed link and the handle main body 3 are approximately the same, and a distance (distance between B1 and B2 in FIG. 2) between the slider at the stroke end position and the connecting shaft (B1) of the fixed link of the second link 12 is formed to be approximately the same as a link length of the first link 11, when an electric rotation operation is performed using the first link 11 as a drive link, the handle device substantially operates as a parallel link of four nodes.

Therefore, when the first link 11 is rotated clockwise from an initial state (see FIG. 2) in which the surface 3b of the handle main body 3 is substantially flush with the door panel (door surface 5), the handle main body 3 moves in parallel to the pop-up position (see FIG. 3).

From this state, when the handle main body 3 is manually rotated clockwise to the latch operation position (see FIG. 4), since the clockwise rotation of the first link 11 around the connecting shaft (A1) with the handle base 2 is restricted, the second link 12 is rotated around the connecting shaft (B1) with respect to the rotation operation of the handle main body 3, and the connecting shaft B2 is translated through the long hole 12a, so that a slider crank mechanism substantially using the handle main body 3, the second link 12, and the slider as movable links is operated, and the second link 12 further rotates by a predetermined angle from the state of FIG. 3B.

On the other hand, the handle base 2 is provided with a latch operation mechanism (not illustrated) which operates by the rotation of the second link 12 around the connecting shaft (B1) with the handle base 2 from FIG. 3 to FIG. 4, and the latch operation mechanism releases a door latch device fixed to the door through an appropriate transmission means such as a cable device in accordance with the rotation of the handle main body 3 to an operation position. Here, the latch operation mechanism may be a switch, and the transmission means may be configured to transmit a signal from the switch to the door latch device.

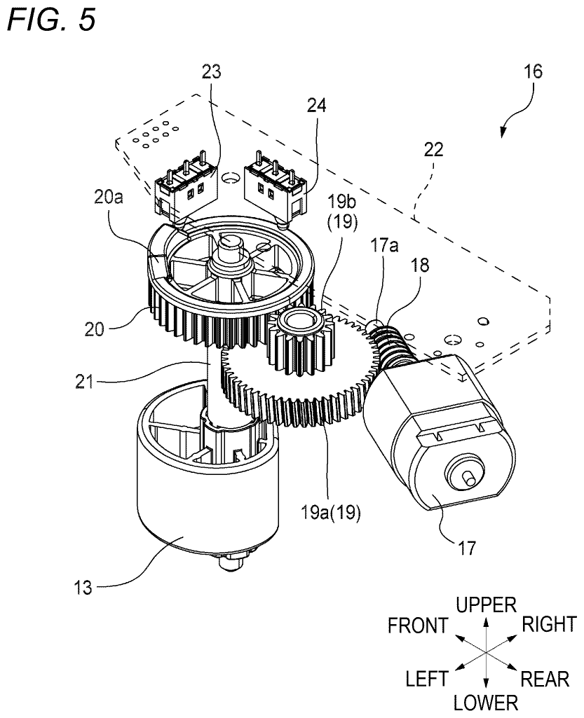

Hereinafter, a detailed configuration of the rotation drive mechanism 16 will be described. As illustrated in FIGS. 5 to 7 and 9, the rotation drive mechanism 16 includes a motor 17, a worm 18, a two-stage gear 19, a main gear 20 (corresponding to a “gear” of the present disclosure), a shaft portion 21 of the main gear 20, a circuit board 22, an initial position detection sensor 23, a pop-up position detection sensor 24, and the cam member 13.

The rotation drive mechanism 16 operates the worm 18, the two-stage gear 19, the main gear 20, and the cam member 13 in accordance with the operation of the motor 17 to move the handle main body 3 between the initial position and the pop-up position.

In the rotation drive mechanism 16, the initial position detection sensor 23 and the pop-up position detection sensor 24 are mounted on the circuit board 22 on a rotation path of a rib 20a of the main gear 20. Note that, although the initial position detection sensor 23 and the pop-up position detection sensor are tact switches that detect contact with the rib 20a here, it is sufficient that the initial position detection sensor 23 and the pop-up position detection sensor can detect approach of the rib 20a, and for example, it is possible to provide a magnet instead of the rib 20a, and use a Hall sensor that detects approach of the magnet, or to replace it with other non-contact sensors. When the initial position detection sensor 23 or the pop-up position detection sensor 24 detects the rib 20a, it is detected that the handle main body 3 is disposed at the initial position or the pop-up position from a rotation angle of the cam member 13 via the main gear 20, and the operation of the motor 17 (that is, rotational drive of the cam member 13) is controlled using a detection result. Hereinafter, each unit will be described in detail.

As illustrated in FIGS. 5 to 7, the motor 17 includes a motor shaft 17a and rotates the motor shaft 17a by receiving power supply. The worm 18 is a screw-shaped gear and is attached to a distal end side of the motor shaft 17a.

The two-stage gear 19 is a gear in which a first gear 19a and a second gear 19b having different numbers of teeth have coaxial rotation axis and are integrally provided in a state of being overlapped in two stages. In the two-stage gear 19, the first gear 19a is disposed in a state of meshing with the worm 18, and the second gear 19b is disposed in a state of meshing with the main gear 20. The number of teeth of the first gear 19a is larger than the number of teeth of the second gear 19b. The two-stage gear 19 rotates as the worm 18 rotates.

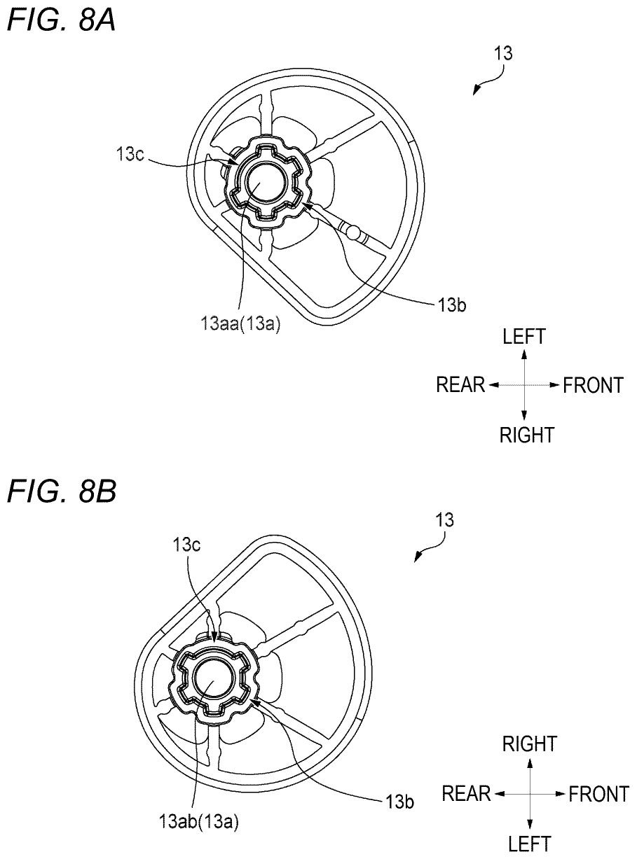

The main gear 20 is a gear that meshes with the second gear 19b of the two-stage gear 19. On an upper surface of the main gear 20, an arc-shaped rib 20a as a detected portion is provided corresponding to a circumferential shape of the main gear 20. The shaft portion 21 is integrally provided on a lower surface of the main gear 20, and a lower end portion thereof is a fitting portion 21a that is fitted to a fitted portion 13a (an upper region 13aa in the aspects illustrated in FIGS. 1 to 8A, and a lower region 13ab in the aspect illustrated in FIGS. 8B to 9) in the cam member 13. Therefore, the fitting portion 21 a is formed in a shape corresponding to the fitted portion 13a of the cam member 13. The fitting portion 21a is provided with a plurality of (five in this example) protruding portions protruding in a radial direction and extending in the upper-lower direction, and the protruding portions are fitted into groove portions of the fitted portion 13a to be described later.

The circuit board 22 is, for example, a printed circuit board on which a circuit for controlling the operation of the motor 17 is mounted. Here, the surface of the circuit board 22 on the main gear 20 side is defined as a surface A, and the opposite surface is defined as a surface B. On the surface A of the circuit board, the initial position detection sensor 23 and the pop-up position detection sensor 24 are mounted on the rotation path of the rib 20a of the main gear 20. That is, the contact of the rib 20a with the initial position detection sensor 23 or the pop-up position detection sensor 24 is detected by a circuit or the like mounted on the circuit board 22.

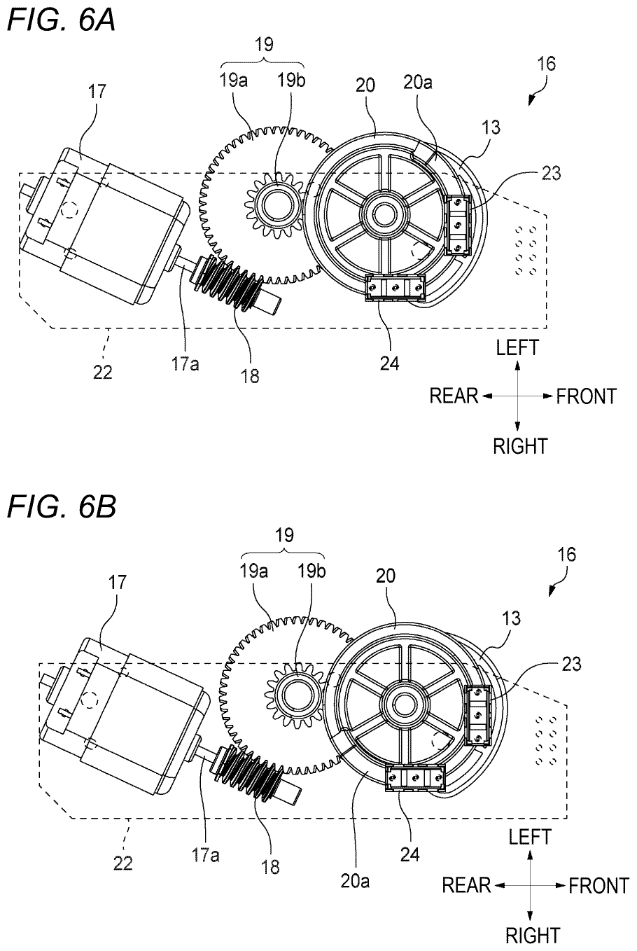

The circuit board 22 is formed to be vertically symmetrical, and can be used by reversing an upper side surface and a lower side surface (particularly, see FIGS. 6A, 6B, and 9). That is, the surface B can be the main gear 20 side, and the initial position detection sensor 23 and the pop-up position detection sensor 24 can be mounted on the surface B. Therefore, it is sufficient to mount the components by reversing the front and back of the circuit board according to the left and right convenience, and the circuit board can be shared.

The cam member 13 is a member that is rotationally driven in accordance with the rotation of the main gear 20 to drive the first link 11. As illustrated in FIGS. 8A and 8B, the cam member 13 is formed with the fitted portion 13a which extends in the upper-lower direction and to which the fitting portion 21a of the main gear 20 is fitted.

The fitted portion 13a is a substantially cylindrical through hole, and includes uneven regions 13b provided with a plurality of (five in this example) groove portions into which the protruding portions of the fitting portion 21a are fitted, and arc regions 13c in which the plurality of groove portions are not provided.

An outer peripheral shape of the cam member 13 is formed vertically symmetrically. On the other hand, as described above, in the fitted portion 13a, in the upper region 13aa and the lower region 13ab, the uneven region 13b and the arc region 13c are positionally deviated in a circumferential direction (in this example, displaced by 60 degrees around a rotation axis). That is, in the cam member 13, the fitted portion 13a is formed to be opposite-handed. Accordingly, in the handle device 1, the cam member 13 can be used regardless of whether the handle device 1 is fixed to the left or right door of the vehicle without preparing the opposite-handed cam member.

A mark or the like is attached to at least one of an upper end surface and a lower end surface of the cam member 13 to clarify a use direction of the cam member 13. In addition, in the fitted portion 13a, an amount of positional deviation in the circumferential direction of the uneven region 13b and the arc region 13c in the upper region 13aa and the lower region 13ab is appropriately determined in consideration of mounting positions of the initial position detection sensor 23 and the pop-up position detection sensor 24 on the circuit board 22, a positional relationship between each detection sensor and the rib 20a of the main gear 20, and the like.

As described above, according to the present embodiment, since a shape of the fitted portion 13a in the cam member 13 is different between the upper region 13aa and the lower region 13ab (that is, the shape of the fitted portion is formed to be opposite-handed), regardless of whether the handle device 1 is fixed to the left or right door of the vehicle, the components including the cam member 13 can be shared without preparing the opposite-handed cam member in accordance with the left and right handle devices as in the handle device of the related art.

According to the present embodiment, since the fitted portion 13a is formed such that a fitting angle with the main gear 20 is different between the upper region 13aa and the lower region 13ab, the shape of the fitted portion 13a can be formed to be opposite-handed by adjusting the fitting angle. That is, according to the present embodiment, the components including the cam member 13 can be shared with a simple structure regardless of whether the handle device is fixed to the left or right door of the vehicle.

According to the present embodiment, since the uneven region 13b and the arc region 13c are positionally deviated in the circumferential direction between the upper region 13aa and the lower region 13ab of the fitted portion 13a, the shape of the fitted portion 13a can be formed to be opposite-handed by adjusting the amount of positional deviation (that is, a magnitude of the angle of positional deviation about the rotation axis). That is, according to the present embodiment, regardless of whether the handle device 1 is fixed to the left or right door of the vehicle, the components including the cam member 13 can be shared with a simple structure.

According to the present embodiment, since the initial position detection sensor 23, the pop-up position detection sensor 24, and the circuit board 22 on which the initial position detection sensor 23 and the pop-up position detection sensor 24 are mounted are further provided, it is easy to control the movement of the handle main body 3 between the initial position and the pop-up position.

According to the present embodiment, since the circuit board 22 is formed symmetrically with respect to the front and back sides, the circuit board 22 can be shared regardless of whether the handle device 1 is fixed to the left or right door of the vehicle.

The present disclosure is not limited to the embodiment described above, and modifications, improvements, and the like can be made as appropriate. In addition, materials, shapes, dimensions, numbers, arrangement positions, and the like of the constituent elements in the embodiment described above are optional and are not limited as long as the present disclosure can be achieved.

For example, in the embodiment described above, the handle device 1 has a slider crank structure using a link, but may be a rotating type handle device in which the handle main body 3 is directly pivotally supported by the handle base 2. Further, in the embodiment described above, the handle main body 3 is a pop-up handle that pops up, but may be a retractable handle in which the handle main body is stored in a door. In the embodiment described above, a rotation shaft of the handle main body 3 extends in the upper-lower direction of the vehicle, but the rotation shaft of the handle main body 3 may extend in the left-right direction of the vehicle.

A vehicle handle device (1) according to the present disclosure including:
a handle base (2) fixed to a vehicle;
a handle main body (3) connected to the handle base (2) and displaceable from an initial position by a drive device (the motor 17);
a gear (the main gear 20) configured to be rotationally driven by the drive device (the motor 17); and
a cam member (13) having a fitted portion (13a) fitted to a fitting portion (21a) formed at a shaft end portion of the gear (the main gear 20) and configured to be rotationally driven by the gear (the main gear 20) via the fitted portion (13a), in which
the handle main body (3) includes a driven portion (11a) in contact with the cam member (13) and is displaceable by the cam member (13) via the driven portion (11a), and
in the cam member (13), the fitted portion (13a) thereof is formed at each of both ends of the cam member (13) in a rotation axis direction, and a shape of the fitted portion (13a) is different between one end side and the other end side in the rotation axis direction.

According to this configuration, the shape of the fitted portion in the cam member is different between the one end side and the other end side in the rotation axis direction. Here, in general, the handle device of the related art is fixed to each of the doors on both the left and right sides of the vehicle in some cases, and it is necessary to prepare an opposite-handed cam member in accordance with the left and right handle devices. However, according to this configuration, since the shape of the fitted portion is different between the one end side and the other end side in the rotation axis direction, that is, the shape of the fitted portion is formed to be opposite-handed, the components can be shared regardless of whether the handle device is fixed to the left or right door of the vehicle.

The shape of the fitted portion (13a) may be shaped such that a fitting angle between the gear (the main gear 20) and the cam member (13) is different between the one end side and the other end side.

According to this configuration, since the fitted portion is formed such that the fitting angle with the gear is different between the one end side and the other end side, the shape of the fitted portion can be formed to be opposite-handed by adjusting the fitting angle. That is, according to this configuration, the components can be shared with a simple structure regardless of whether the handle device is fixed to the left or right door of the vehicle.

One of the fitting portion (21a) and the fitted portion (13a) may be formed in a substantially columnar shape, the other of the fitting portion (21a) and the fitted portion (13a) may be formed in a substantially cylindrical shape, the fitting portion (21a) may be provided with one of a protruding portion protruding in a radial direction and a groove portion fitted to the protruding portion, the fitted portion may be provided with the other of the protruding portion and the groove portion, the fitted portion may have an uneven region (13b) in which the protruding portion or the groove portion is provided and an arc region (13c) in which the protruding portion or the groove portion is not provided, and the uneven region (13b) and the arc region (13c) may be positionally deviated in a circumferential direction between the one end side and the other end side.

According to this configuration, since the uneven region and the arc region are positionally deviated in the circumferential direction between the one end side and the other end side of the fitted portion, the shape of the fitted portion can be formed to be opposite-handed by adjusting the amount of positional deviation (that is, the magnitude of the angle of positional deviation about the rotation axis). That is, according to this configuration, the components can be shared with a simple structure regardless of whether the handle device is fixed to the left or right door of the vehicle.

An initial position detection sensor (23) configured to detect that the handle main body (3) is disposed at the initial position, a pop-up position detection sensor (24) configured to detect that the handle main body (3) is disposed at a pop-up position pulled out from the initial position, and a circuit board (22) on which the initial position detection sensor (23) and the pop-up position detection sensor (24) are mounted may be further provided.

According to this configuration, since the initial position detection sensor, the pop-up position detection sensor, and the circuit board on which the initial position detection sensor and the pop-up position detection sensor are mounted are further provided, it is easy to control the movement of the handle main body between the initial position and the pop-up position.

The gear (the main gear 20) may have a detected portion (the rib 20a) on a circumference of a rotation surface of the gear (the main gear 20), the circuit board (22) may be configured such that the initial position detection sensor (23) and the pop-up position detection sensor (24) are disposed on a surface facing the detected portion (the rib 20a), the vehicle handle device (1) may be configured such that the initial position detection sensor (23) detects approach of the detected portion (the rib 20a) to detect that the handle main body (3) is disposed at the initial position, and the pop-up position detection sensor (24) detects the approach of the detected portion (the rib 20a) to detect that the handle main body (3) is disposed at the pop-up position, and the circuit board (22) may be formed such that a front surface and a back surface are symmetrical.

According to this configuration, since the circuit board is formed such that a front surface and a back surface are symmetrical, regardless of whether the handle vehicle is fixed to the left or right door of the vehicle, it is only necessary to mount the components by reversing the front and back surfaces of the circuit board, and the circuit board can be shared.

Although various embodiments have been described above, it is needless to say that the present disclosure is not limited to such embodiments. It is apparent to those skilled in the art that various variations or modifications can be conceived within the scope described in the claims, and it is understood that the variations or modifications naturally fall within the technical scope of the present disclosure. Further, the components described in the above embodiments may be freely combined without departing from the spirit of the disclosure.

What is claimed is:

1. A vehicle handle device comprising:
a handle base fixed to a vehicle;
a handle main body connected to the handle base and displaceable from an initial position by a drive device;
a gear configured to be rotationally driven by the drive device; and
a cam member having a fitted portion fitted to a fitting portion formed at a shaft end portion of the gear and configured to be rotationally driven by the gear via the fitted portion,
wherein the handle main body includes a driven portion in contact with the cam member and is displaceable by the cam member via the driven portion, and
wherein in the cam member, the fitted portion thereof is formed at each of both ends of the cam member in a rotation axis direction, and a shape of the fitted portion is different between one end side and the other end side in the rotation axis direction.

2. The vehicle handle device according to claim 1,
wherein the fitted portion is shaped such that a fitting angle between the gear and the cam member is different between the one end side and the other end side.

3. The vehicle handle device according to claim 1,
wherein one of the fitting portion and the fitted portion is formed in a substantially columnar shape,
wherein the other of the fitting portion and the fitted portion is formed in a substantially cylindrical shape,
wherein the fitting portion is provided with one of a protruding portion protruding in a radial direction and a groove portion fitted to the protruding portion,
wherein the fitted portion is provided with the other of the protruding portion and the groove portion, and
wherein the fitted portion has an uneven region in which the protruding portion or the groove portion is provided and an arc region in which the protruding portion or the groove portion is not provided, and the uneven region and the arc region are positionally deviated in a circumferential direction between the one end side and the other end side.

4. The vehicle handle device according to claim 1, further comprising:
an initial position detection sensor configured to detect that the handle main body is disposed at the initial position;
a pop-up position detection sensor configured to detect that the handle main body is disposed at a pop-up position pulled out from the initial position; and
a circuit board on which the initial position detection sensor and the pop-up position detection sensor are mounted.

5. The vehicle handle device according to claim 4,
wherein the gear has a detected portion on a circumference of a rotation surface of the gear,
wherein the circuit board is configured such that the initial position detection sensor and the pop-up position detection sensor are disposed on a surface facing the detected portion,
wherein the vehicle handle device is configured such that the initial position detection sensor detects approach of the detected portion to detect that the handle main body is disposed at the initial position, and the pop-up position detection sensor detects the approach of the detected portion to detect that the handle main body is disposed at the pop-up position, and
wherein the circuit board is formed such that a front surface and a back surface are symmetrical.
